(19) United States
(12) Patent Application Publication
(10) Pub. No.: US 2015/0209812 A1
(43) Pub. Date: Jul. 30, 2015

(54) DEVICE AND METHOD FOR REPAIRING PATTERN ON ARRAY SUBSTRATE

(71) Applicant: Yung-yu Lin, Shenzhen (CN)

(72) Inventor: Yung-yu Lin, Shenzhen (CN)

(73) Assignee: SHENZHEN CHINA STAR OPTOELECTRONICS TECHNOLOGY CO., LTD., Shenzhen (CN)

(21) Appl. No.: 13/695,622

(22) PCT Filed: Sep. 3, 2012
(86) PCT No.: PCT/CN2012/080938

§ 371 Date: Mar. 29, 2015

(30) Foreign Application Priority Data
Aug. 31, 2012 (CN) 201210319176.4

(51) Int. Cl. B05B 12/08; B05D 1/02

(52) U.S. Cl. CPC B05B 12/084; B05D 1/02

(57) ABSTRACT

The present invention provides a device and method for repairing a pattern on an array substrate, said device comprising: an illuminating unit, for illuminating a mask after the mask is disposed above a substrate so as to expose a layer on the substrate that is to be etched to light to form an exposed pattern on that layer; a checking unit, for checking the exposed pattern on the layer to be etched for determining whether a coating defect is occurred in the exposed pattern; and a coating unit, for coating a protection layer at where the coating defect is located when the coating defect is determined to be existed in the exposed pattern. The present invention not only has high efficiency, but also low cost.

### BACKGROUND OF THE INVENTION

1. Field of the Invention

The present invention relates to a liquid crystal manufacture field, and more particularly, relates to a device and method for repairing a pattern on an array substrate.

2. Description of Prior Art

As liquid crystal manufacture technology grows vigorously, a demand in liquid crystal production efficiency is highly requested.

During manufacturing a liquid crystal display, a mask is an inevitable element. For example, when manufacturing pixel areas on a thin-film-transistor (TFT) substrate or color filtering areas (e.g., R, G, and B) on a color filter (CF) substrate, they all need the mask.

Referring to FIG. 1, which is a schematic structural diagram showing a mask used in conventional skills. The mask 10 comprises a transparent glass 11, a photoresist layer 12 superposed over the transparent glass 11, and a light transmitting area 13 located in a layer as the same as the photoresist layer 12. The light transmitting area 13 is formed between the photoresist layers 12. The photoresist layer 12 is not transparent. The photoresist layer 12 together with the light transmitting area 13 form a masking layout.

In the TFT substrate manufacture, after a layer to be etched is exposed to light via the mask 10, an exposed pattern will be formed on the layer to be etched. At the time, it needs to check the exposed pattern. The results include two situations. The first situation is that a redundant photoresist exists in the exposed pattern. The second situation is that a broken-line defect exists in the exposed pattern. The broken-line defect may be caused by collapse of photoresist bubbles in the layer to be etched.

For the first situation, it can remove the redundant photoresist in the exposed pattern by using a repairing machine. For the second situation, it needs to perform a new mask process onto the substrate having the exposed pattern. Or else, it has to abandon the mask. This is not only a waste, but also affects the liquid crystal production efficiency.

Above all, once the broken-line defect exists in the exposed pattern on the layer to be etched, tackling with the broken-line defect is not only a waste, but also affects the liquid crystal production efficiency.

### SUMMARY OF THE INVENTION

An objective of the present invention is to provide a device for repairing a pattern on an array substrate, for solving the technical problems occurred in conventional skills, including a high cost in tackling with a broken-line defect when a broken line exists in an exposed pattern on a layer to be etched, and a low liquid crystal production efficiency.

To solve above problems, the present invention provides a device for repairing a pattern on an array substrate, said device comprising: an illuminating unit, for illuminating a mask after the mask is disposed above a substrate so as to expose a layer on the substrate that is to be etched to light to form an exposed pattern on that layer; a checking unit, for checking the exposed pattern on the layer to be etched for determining whether a defect of a broken line is occurred in the exposed pattern; a coating unit, for coating a protection layer at where the broken line is located when the defect is determined to be existed in the exposed pattern; and an etching unit, for etching the layer to be etched, having the protection layer formed thereon.

In one embodiment of the present invention, the checking unit comprises: an image capturing unit, for capturing an image of the exposed pattern; and a display unit, for showing the image captured by the image capturing unit to operating personnel, the operating personnel judging whether a coating defect is occurred in the exposed pattern.

In one embodiment of the present invention, the coating unit comprises a nozzle.

An objective of the present invention is to provide a device for repairing a pattern on an array substrate, for solving the technical problems occurred in conventional skills, including a high cost in tackling with a broken-line defect when a broken line exists in an exposed pattern on a layer to be etched, and a low liquid crystal production efficiency.

To solve above problems, the present invention provides a device for repairing a pattern on an array substrate, said device comprising: an illuminating unit, for illuminating a mask after the mask is disposed above a substrate so as to expose a layer on the substrate that is to be etched to light to form an exposed pattern on that layer; a checking unit, for checking the exposed pattern on the layer to be etched for determining whether a coating defect is occurred in the exposed pattern; and a coating unit, for coating a protection layer at where the coating defect is located when the coating defect is determined to be existed in the exposed pattern.

In one embodiment of the present invention, the checking unit comprises: an image capturing unit, for capturing an image of the exposed pattern; and a display unit, for showing the image captured by the image capturing unit to operating personnel, the operating personnel judging whether the coating defect exists in the exposed pattern.

In one embodiment of the present invention, the device further comprising: an etching unit, for etching the layer to be etched, having the protection layer formed thereon.

In one embodiment of the present invention, the coating unit comprises a nozzle.

In one embodiment of the present invention, the coating defect is a broken line.

Another objective of the present invention is to provide a method for repairing a pattern on an array substrate, for solving the technical problems occurred in conventional skills, including a high cost in tackling with a broken-line defect when a broken line exists in an exposed pattern on a layer to be etched, and a low liquid crystal production efficiency.

To solve above problems, the present invention provides a method for repairing a pattern on an array substrate, said method comprising: illuminating a mask after the mask is disposed above a substrate so as to expose a layer on the substrate that is to be etched to light to form an exposed pattern on that layer; checking the exposed pattern on the layer to be etched for determining whether a coating defect is occurred in the exposed pattern; and coating a protection layer at where the coating defect is located if the coating defect exists in the exposed pattern.

In one embodiment of the present invention, the step of checking the exposed pattern on the layer to be etched comprises: capturing an image of the exposed pattern; and showing the captured image, operating personnel judging whether the coating defect exists in the exposed pattern.

In one embodiment of the present invention, after coating the protection layer at where the coating defect is located, said method further comprises: etching the layer to be etched, having the protection layer formed thereon.

In one embodiment of the present invention, the step of coating the protection layer at where the coating defect is located comprises: utilizing a nozzle to coat the protection layer at where the coating defect is located.

In one embodiment of the present invention, the coating defect is a broken line.

Compared to conventional skills, the present invention adds the coating unit (e.g., a nozzle) on a basis of a conventional repairing machine. When it is determined that the coating defect exists in the exposed pattern, the protection layer is directly coated at where the coating defect is located by using the coating unit. Obviously, the present invention does not have to abandon the array substrate having the coating defect. Instead, it is to coat the protection layer directly at where the coating defect is located. The present invention not only has high efficiency, but also low cost.

To make above content of the present invention more easily understood, it will be described in details by using preferred embodiments in conjunction with the appending drawings.

### BRIEF DESCRIPTION OF THE DRAWINGS

FIG. 1 is a schematic structural diagram showing a mask in conventional skills.

FIG. 2 is a schematic structural diagram showing a device for repairing a pattern on an array substrate according to a preferred embodiment provided in the present invention.

FIGS. 3A to 3C are schematic structural diagrams illustrating exposed patterns in respective operational stages of repairing a pattern on an array substrate according to the present invention.

FIG. 4 is a flow chart of a method for repairing a pattern on an array substrate according to the present invention.

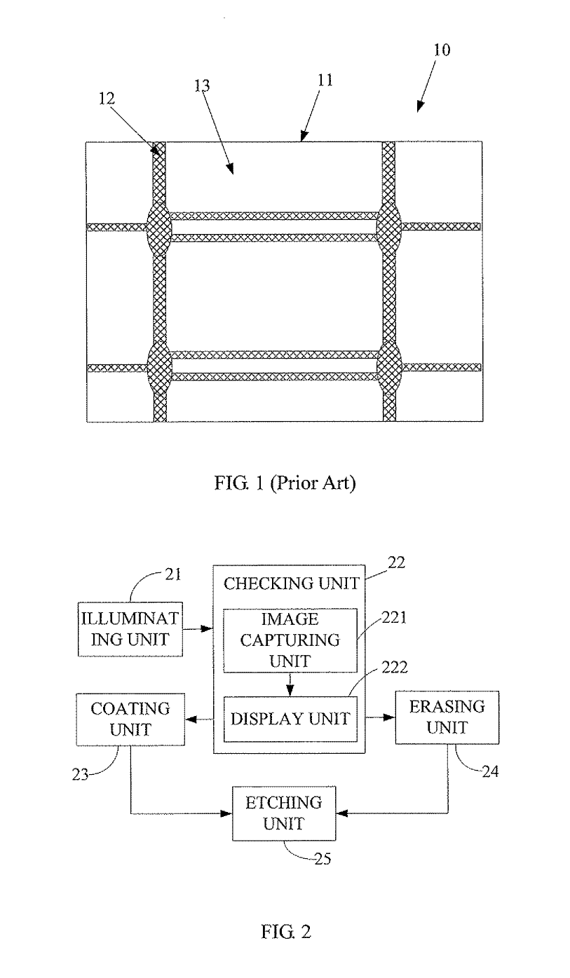

### DETAILED DESCRIPTION OF THE PREFERRED EMBODIMENTS

The following descriptions for the respective embodiments are specific embodiments capable of being implemented for illustrations of the present invention with referring to appended figures. In the descriptions of the present invention, spatially relative terms, such as “upper”, “lower”, “front”, “back”, “left”, “right”, “top”, “bottom”, “horizontal”, “vertical”, and the like, may be used herein for ease of description as illustrated in the figures. Therefore, it will be understood that the spatially relative terms are intended to illustrate for understanding the present invention, but not to limit the present invention. In the appending drawings, units having similar structures are labeled by the same reference numbers.

FIG. 2 is a schematic structural diagram showing a device for repairing a pattern on an array substrate according to a preferred embodiment provided in the present invention.

The pattern repairing device for the array substrate comprises an illustrating unit 21, a checking unit 22, a coating unit 23, an erasing unit 24, and an etching unit 25. The checking unit 22 comprises an image capturing unit 221 and a display unit 222.

The illuminating unit 21 is utilized to illuminate a mask after the mask is disposed above a substrate so as to expose a layer on the substrate that is to be etched to light to form an exposed pattern on that layer. The checking unit 22 is utilized to check the exposed pattern on the layer to be etched. The results may include the following two situations. The first is that a coating defect (e.g., a broken line) is occurred in the exposed pattern. The second is that the exposed pattern may have a photoresist that is to be erased or need to be erased, for example, a redundant photoresist.

Specifically, the image capturing unit 221 of the checking unit 22 is utilized to capture an image of the exposed pattern. The display unit 222 of the checking unit 22 is utilized to show the image captured by the image capturing unit 221 to operating personnel. Whether the coating defect or the photoresist that is to be erased exists in the exposed pattern is judged by the operating personnel.

If the exposed pattern has the coating defect, the coating unit 23 coats a protection layer at where the coating defect is located. The protection layer can protect a photoresist located corresponding to the coating defect from being etched in subsequent processes. After that, the etching unit 25 etches the layer to be etched, having the protection layer formed thereon. If the exposed pattern has the photoresist that is to be erased, the erasing unit 24 erases or removes the photoresist to be erased. After that, the etching unit 25 etches the layer that is to be etched.

The coating defect of the exposed pattern can be a defect of a broken line, or any other type of defect. Preferably, the coating unit 23 comprises a nozzle.

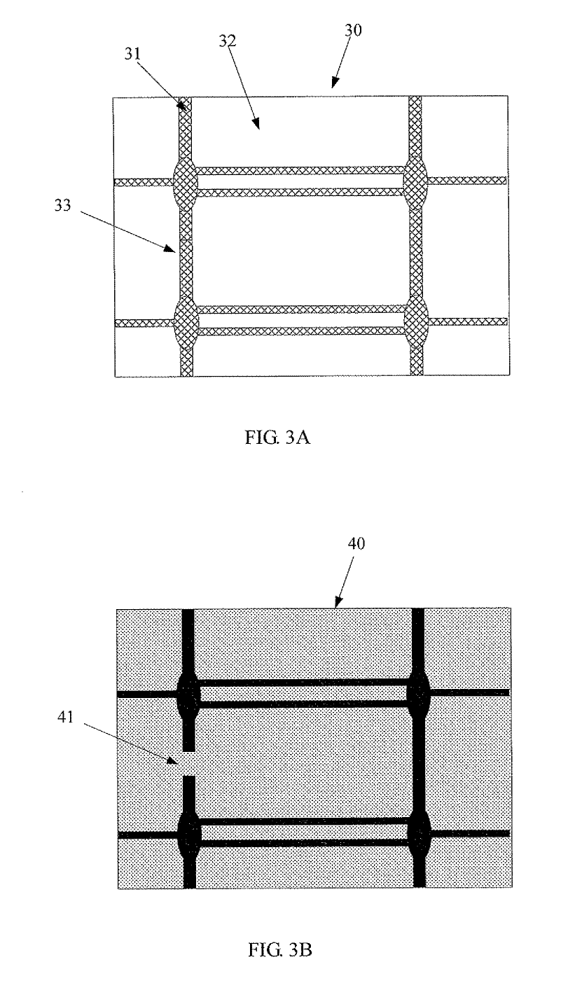

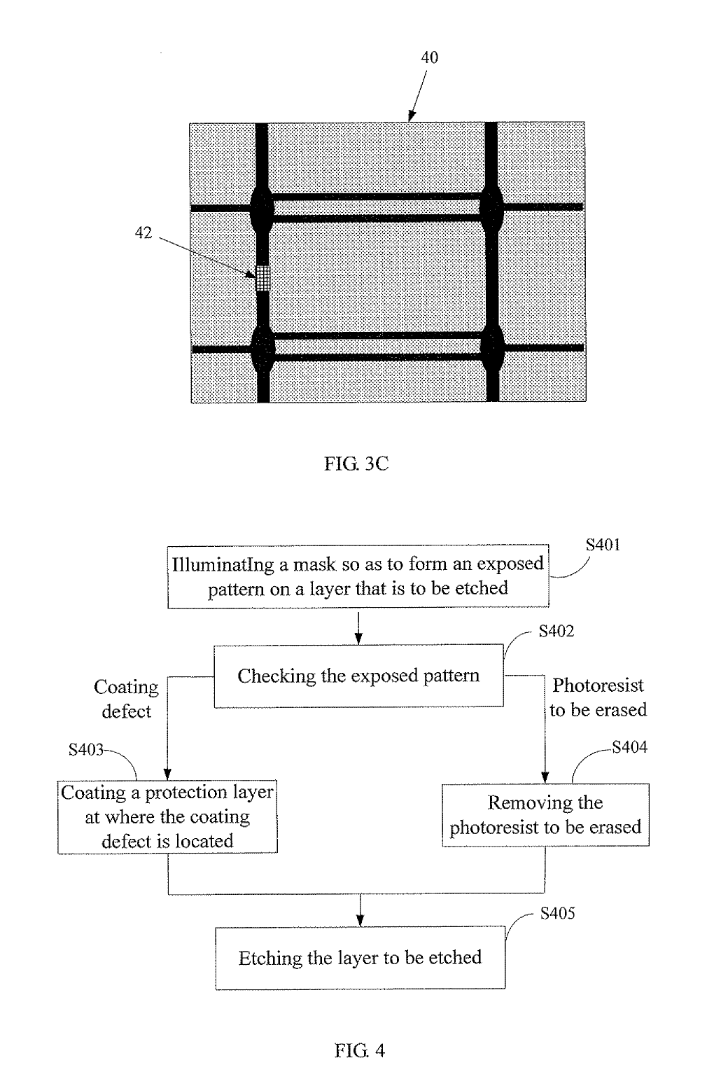

The operations of the pattern repairing device for the array substrate provided in the present invention are illustrated in accompany with FIG. 3A to FIG. 3C.

A mask 30 is provided as shown in FIG. 3A. The mask 30 has a masking layout. The masking layout has a light blocking section 31 and a light transmitting section 32. The light blocking section 31 is made by coating a photoresist material and is utilized to block light rays.

The mask 30 is disposed above a substrate 40. Please further refer to FIG. 3B. A layer to be etched (not labeled) is coated on the substrate 40. After that, the illuminating unit 21 is operated to illuminate the mask 30 so as to form an exposed pattern on the layer to be etched on the substrate 40.

Next, the checking unit 22 is operated to check the exposed pattern. Specifically, an image of the exposed pattern is obtained by using the image capturing unit 221. The obtained image of the exposed pattern is presented to operating personnel by using the display unit 222. On the substrate 40 shown in FIG. 3B, a broken-line defect exists in the exposed pattern.

Next, the substrate 40 is arranged on a flat stand. The coating unit 23 is operated to coat a protection layer 42 at where the broken-line defect is located. Referring to FIG. 3C, for example, the protection layer 42 can be made of a photoresist material. The protection layer 42 is utilized to protect a corresponding layer from being etched.

The present invention adds the coating unit 23 (e.g., a nozzle) on a basis of a conventional repairing machine. When it is determined that the broken-line defect 41 is occurred in the exposed pattern on the substrate 40, the protection layer 42 is directly coated at where the broken-line defect 41 is located by using the coating unit 23. It does not have to abandon the substrate 40 having the broken-line defect 42 or start a new mask process. The present invention not only has high efficiency, but also low cost.

FIG. 4 is a flow chart of a method for repairing a pattern on an array substrate according to the present invention.

In Step S401, after a mask is disposed above a substrate, the mask is illuminated so as to expose a layer on the substrate that is to be etched to light to form an exposed pattern on that layer.

In Step S402, the exposed pattern is checked. If it is determined that a coating defect is occurred in the exposed pattern, go to Step S403; If it is determined that the exposed pattern has a photoresist that is to be erased or needs to be erased, go to Step S404.

Specifically, the step of checking the exposed pattern comprises: capturing an image of the exposed pattern; and showing the captured image to operating personnel. The operating personnel judges whether defects are existed in the exposed pattern. The results may include two situations. One situation is that the coating defect (e.g., a broken-line defect) is occurred in the exposed pattern. The other situation is that the exposed pattern has a photoresist that is to be erased or need to be erased.

In Step S403, a protection layer is coated at where the coating defect is located.

In Step S404, the photoresist that is to be erased is removed or erased.

In Step S405, the layer that is to be etched is etched.

Preferably in the present invention, a nozzle is utilized to coat the protection layer at where the coating defect is located.

The present invention adds the coating unit (e.g., a nozzle) on a basis of a conventional repairing machine. When it is determined that the coating defect exists in the exposed pattern, the protection layer is directly coated at where the coating defect is located by using the coating unit. Obviously, the present invention does not have to abandon the array substrate having the coating defect. Instead, it is to coat the protection layer directly at where the coating defect is located. The present invention not only has high efficiency, but also low cost.

Although the present invention has been explained by the embodiments shown in the drawings described above, it should be understood to the ordinary skilled person in the art that the invention is not limited to the embodiments, but rather various changes or modifications thereof are possible without departing from the spirit of the invention. Accordingly, the scope of the invention shall be determined only by the appended claims and their equivalents.

What is claimed is:

1. A device for repairing a pattern on an array substrate, said device comprising:
an illuminating unit, for illuminating a mask after the mask is disposed above a substrate so as to expose a layer on the substrate that is to be etched to light to form an exposed pattern on that layer;
a checking unit, for checking the exposed pattern on the layer to be etched for determining whether a defect of a broken line is occurred in the exposed pattern;
a coating unit, for coating a protection layer at where the broken line is located when the defect is determined to be existed in the exposed pattern; and
an etching unit, for etching the layer to be etched, having the protection layer formed thereon.

2. The device according to claim 1, wherein the checking unit comprises:
an image capturing unit, for capturing an image of the exposed pattern; and
a display unit, for showing the image captured by the image capturing unit to operating personnel, the operating personnel judging whether a coating defect is occurred in the exposed pattern.

3. The device according to claim 1, wherein the coating unit comprises a nozzle.

4. A device for repairing a pattern on an array substrate, said device comprising:
an illuminating unit, for illuminating a mask after the mask is disposed above a substrate so as to expose a layer on the substrate that is to be etched to light to form an exposed pattern on that layer;
a checking unit, for checking the exposed pattern on the layer to be etched for determining whether a coating defect is occurred in the exposed pattern; and
a coating unit, for coating a protection layer at where the coating defect is located when the coating defect is determined to be existed in the exposed pattern.

5. The device according to claim 4, wherein the checking unit comprises:
an image capturing unit, for capturing an image of the exposed pattern; and
a display unit, for showing the image captured by the image capturing unit to operating personnel, the operating personnel judging whether the coating defect exists in the exposed pattern.

6. The device according to claim 4, further comprising:
an etching unit, for etching the layer to be etched, having the protection layer formed thereon.

7. The device according to claim 4, wherein the coating unit comprises a nozzle.

8. The device according to claim 4, wherein the coating defect is a broken line.

9. A method for repairing a pattern on an array substrate, said method comprising:
illuminating a mask after the mask is disposed above a substrate so as to expose a layer on the substrate that is to be etched to light to form an exposed pattern on that layer;
checking the exposed pattern on the layer to be etched for determining whether a coating defect is occurred in the exposed pattern; and
coating a protection layer at where the coating defect is located if the coating defect exists in the exposed pattern.

10. The method according to claim 9, wherein the step of checking the exposed pattern on the layer to be etched comprises:
capturing an image of the exposed pattern; and
showing the captured image, operating personnel judging whether the coating defect exists in the exposed pattern.

11. The method according to claim 9, wherein after coating the protection layer at where the coating defect is located, said method further comprises:
etching the layer to be etched, having the protection layer formed thereon.

12. The method according to claim 9, wherein the step of coating the protection layer at where the coating defect is located comprises:
utilizing a nozzle to coat the protection layer at where the coating defect is located.

13. The method according to claim 9, wherein the coating defect is a broken line.
